(19) United States
(12) Patent Application Publication
(10) Pub. No.: US 2025/0079443 A1
(43) Pub. Date: Mar. 6, 2025

(54) POSITIVE PLATE AND PREPARATION METHOD THEREOF AND SODIUM-ION BATTERY

(71) Applicant: JIANGSU PYLON BATTERY CO., LTD., Yangzhou City, Jiangsu (CN)

(72) Inventors: Zewen RUAN, Yangzhou City, Jiangsu (CN); Cheng YANG, Yangzhou City, Jiangsu (CN); Xueping HU, Yangzhou City, Jiangsu (CN); Yishuang YANG, Yangzhou City, Jiangsu (CN); Qingheng YANG, Yangzhou City, Jiangsu (CN)

(21) Appl. No.: 18/283,464

(22) PCT Filed: Dec. 9, 2022
(86) PCT No.: PCT/CN2022/138078

§ 371 Date: Sep. 22, 2023

(30) Foreign Application Priority Data
Nov. 29, 2022 (CN) 202211514774.7

(51) Int. Cl. H01M 4/36; H01M 4/02; H01M 4/04; H01M 4/131; H01M 4/1391; H01M 4/505; H01M 4/525; H01M 4/58; H01M 4/62; H01M 10/054

(52) U.S. Cl. CPC H01M 4/366; H01M 4/0404; H01M 4/043; H01M 4/131; H01M 4/1391; H01M 4/505; H01M 4/525; H01M 4/5825; H01M 4/623; H01M 4/625; H01M 10/054; H01M 2004/021; H01M 2004/028

(57) ABSTRACT

A positive plate and a preparation method thereof, and a sodium-ion battery are provided. The positive plate includes a current collector and at least one cathode material layer provided on at least one side surface of the current collector. The at least one cathode material layer includes a layered transition metal oxide and a polyanionic compound. A mass ratio of the layered transition metal oxide to the polyanionic compound is (\sqrt{2}+1)ρ₁/ρ₂˜4(\sqrt{2}+1)ρ₁/ρ₂, wherein ρ₁ indicates a true density of the layered transition metal oxide, ρ₂ indicates a true density of the polyanionic compound, and 1.25≤ρ₁/ρ₂≤1.86. A particle size distribution of the layered transition metal oxide satisfies: (\sqrt{3}-\sqrt{2})D₅₀≤D₁₀≤(\sqrt{2}−1)D₅₀, and a particle size of the polyanionic compound satisfies:

$${{D}^{′}}_{50} \leq \frac{( \sqrt{2} - 1 )}{4} {D}_{50} .$$

### BACKGROUND OF THE INVENTION

### 1. Field of the Invention

The present disclosure relates to the technical field of battery technology, and particularly, to a positive plate and a preparation method thereof and a sodium-ion battery.

### 2. Description of the Prior Art

With the widespread application of lithium-ion batteries in the field of electric vehicles, the demand for lithium resources has greatly increased. However, the reserve of lithium in the Earth's crust only accounts for 0.0017%, and there is still no effective lithium resource recovery technology, which obviously cannot meet the growing needs in fields such as large-scale energy storage and electric vehicles. Therefore, from the perspective of sustainable development and utilization of energy, it is very important to seek a new rechargeable battery system with low cost, high safety, and long cycle life. The reserve of sodium in the Earth's crust accounts for about 2.36% (mass fraction), which is much higher than that of lithium, and sodium is widely distributed and low in cost. At the same time, sodium and lithium belong to the same main group element, and both exhibit similar “rocking chair” electrochemical charge and discharge behaviors in battery work. Therefore, the development of high-performance and low-cost sodium-ion battery technology is of great significance for the sustainable development of fields such as large-scale energy storage and electric vehicles.

At present, the most promising cathode materials of sodium-ion batteries mainly include layered transition metal oxides and polyanionic compounds. Among them, the layered transition metal oxides exhibit higher capacity per gram and meet the needs of high energy density, however, have poor air stability, and are easy to undergo ion exchange reactions with hydrogen ions of water molecules in the air, and generate alkaline oxides such as Na₂CO₃, NaHCO₃, and NaOH on the surface of the material and directly absorb water molecules as interlayer crystallization water, which may change the crystal structure of the material and reduce the crystallinity of the material. The formation of a strongly alkaline environment on the surface of the material will cause the bonding agent to be defluorinated and fail, and the alkali will corrode the current collector aluminum foil with amphoteric metal characteristics, which will seriously affect the performance of the battery. At present, the commonly used solution in the industry is to make the layered transition metal oxides of the material into micron-sized polycrystalline or monocrystalline particles, which are supplementarily subjected to doping or coating improvement, which however cannot effectively improve the air stability of the material. Polyanionic compounds have attracted much attention due to their stable skeleton structure, excellent cycle performance, and good air stability, but their poor intrinsic electronic conductivity also poses challenges to the large-scale use of the material. At present, the main improvement methods include nano-crystallization and carbon compounding, which however reduce the volumetric energy density of the material.

In view of this, the present disclosure is hereby proposed.

### SUMMARY OF THE INVENTION

An object of the present disclosure is to provide a positive plate, to solve the technical problems of poor air stability and low volumetric energy density of the positive plate in the prior art.

Another object of the present disclosure is to provide a preparation method for the positive plate.

Another object of the present disclosure is to provide the sodium-ion battery.

In order to realize the above-mentioned objects of the present disclosure, the following technical solutions are specially adopted:
a positive plate, including a current collector and at least one cathode material layer provided on at least one side surface of the current collector, wherein the at least one cathode material layer includes a layered transition metal oxide and a polyanionic compound;
a chemical formula of the layered transition metal oxide includes NaₓMO₂, wherein 0.6≤x≤1.0, and M includes at least one of Fe, Mn, Cr, Ni, Co, Cu, Mg, Zr, and Ti;
a chemical formula of the polyanionic compound includes at least one of NaAPO₄. Na_{y}E₂(XO₄)₃, and Na₂QP₂O₇, wherein A includes Fe and/or Mn, 1≤y≤4, E includes at least one of V, Fe, Ni, Mn, and Ti, X includes at least one of P, S, and Si, and Q includes at least one of Fe, Mn, and Co;
a mass ratio of the layered transition metal oxide to the polyanionic compound is expressed as (\sqrt{2}+1)ρ₁/ρ₂˜4 (\sqrt{2}+1)ρ₁/ρ₂, wherein ρ₁ indicates a true density of the layered transition metal oxide, and ρ₂ indicates a true density of the polyanionic compound, 1.25≤ρ₁/ρ₂≤1.86;
a particle size distribution of the layered transition metal oxide satisfies: (\sqrt{3}−\sqrt{2})D₅₀≤D₁₀≤(\sqrt{2}−1)D₅₀; and
a particle size of the polyanionic compound satisfies:

$${D ’}_{50} \leq \frac{( \sqrt{2} - 1 )}{4} {D}_{50} .$$

In an embodiment, a range of ρ₁ is 4.4˜4.65 g/cm³; and a range of ρ₂ is 2.5˜3.5 g/cm³.

In an embodiment, a particle size D₅₀ of the layered transition metal oxide is 4˜12 μm.

In an embodiment, a particle size D₁₀ of the layered transition metal oxide is 1.27˜3.82 μm.

In an embodiment, a particle size D′₅₀ of the polyanionic compound is 0.41˜1.24 μm.

In an embodiment, the at least one cathode material layer further includes a conductive agent and a bonding agent.

In an embodiment, the conductive agent includes at least one of carbon nanotube, conductive carbon black, conductive graphite, graphene, and carbon fiber.

In an embodiment, the bonding agent include polyvinylidene fluoride.

In an embodiment, a total mass of the conductive agent and the bonding agent accounts for no more than 5% of a mass of the at least one cathode material layer.

In an embodiment, in the at least one cathode material layer, a mass ratio of the conductive agent to the bonding agent is (1.5-3.5):(1.5-3.5).

In an embodiment, a compaction density of the positive plate is 3.0˜3.6 g/cm³.

The preparation method of the positive plate includes the following steps:
preparing a cathode slurry, wherein the cathode slurry contains the layered transition metal oxide and the polyanionic compound; and coating the cathode slurry on the at least one side surface of the current collector, and then performing drying and compacting.

In an embodiment, the cathode slurry further contains a conductive agent, a bonding agent, and a solvent.

In an embodiment, a preparation method of the cathode slurry specifically includes:
dissolving the bonding agent into the solvent, adding the conductive agent and mixing them evenly to obtain a conductive slurry; and mixing the conductive slurry, the layered transition metal oxide, and the polyanionic compound evenly, to obtain a cathode slurry.

In an embodiment, a temperature of the drying is 75˜120° C.

In an embodiment, a pressure adopted by the compacting is 20˜100 MPa.

The sodium-ion battery, including the positive plate.

Compared with the prior art, the beneficial effects of the present disclosure are as follows.
(1) In the present disclosure, the positive plate obtained by controlling the particle size relationship, particle size distribution, and mass ratio relationship between the transition metal oxide and the polyanionic compound may have effectively improved air stability, and also higher compaction density and excellent electrochemical performance.
(2) The preparation method of the positive plate of the present disclosure is simple and easy to be operated, that is, coating the cathode slurry containing the layered transition metal oxide and the polyanionic compound on the at least one side surface of the current collector, and then performing drying and compacting.
(3) The sodium-ion battery obtained by the present disclosure has excellent electrochemical performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

In order to illustrate the technical solutions in the embodiments of the present disclosure or in the prior art more clearly, the drawings that need to be used in the description of the embodiments or the prior art are briefly introduced as follows. Obviously, the drawings in the following description show some embodiments of the present disclosure. For those skilled in the art, other drawings can also be obtained according to these drawings without making any creative efforts.

FIG. 1 is a discharge curve diagram of a cell in Example 1 of the present disclosure; and

FIG. 2 is a curve diagram of a cycle retention rate of a cell in Example 3 of the present disclosure.

### DETAILED DESCRIPTION

Embodiments of the present disclosure will be described in detail below in conjunction with examples, but those skilled in the art will understand that the following examples are only used to illustrate the present disclosure, and should not be considered as limiting the scope of the present disclosure. Those whose specific conditions are not indicated in the examples are carried out according to the conventional conditions or the conditions suggested by the manufacturers. The used reagents or instruments of which the manufacturers are not indicated are all commercially available conventional products.

A positive plate includes a current collector and at least one cathode material layer provided on at least one side surface of the current collector; the at least one cathode material layer includes a layered transition metal oxide and a polyanionic compound.

A chemical formula of the layered transition metal oxide includes NaₓMO₂, wherein 0.6≤x≤1.0, and M includes at least one of Fe, Mn, Cr, Ni, Co, Cu, Mg, Zr, and Ti.

A chemical formula of the polyanionic compound includes at least one of NaAPO₄. Na_{y}E₂(XO₄)₃, and Na₂QP₂O₇, wherein A includes Fe and/or Mn, 1≤y≤4, E includes at least one of V, Fe, Ni, Mn, and Ti, X includes at least one of P, S, and Si, and Q includes at least one of Fe, Mn, and Co.

A mass ratio of the layered transition metal oxide to the polyanionic compound is expressed as (\sqrt{2}+1)ρ₁/ρ₂˜4(\sqrt{2}+1)ρ₁/ρ₂, wherein ρ₁ indicates a true density of the layered transition metal oxide, and ρ₂ indicates a true density of the polyanionic compound, 1.25≤ρ₁/ρ₂≤1.86.

A particle size distribution of the layered transition metal oxide satisfies: (\sqrt{3}−\textcircled{2})D₅₀≤D₁₀≤(\sqrt{2}−1)D₅₀.

A particle size of the polyanionic compound satisfies:

$${D ’}_{50} \leq \frac{( \sqrt{2} - 1 )}{4} {D}_{50} .$$

In the present disclosure, the positive plate obtained by controlling the particle size relationship, particle size distribution, and mass ratio relationship between the transition metal oxide and the polyanionic compound may have not only effectively improved air stability, but also higher compaction density and excellent electrochemical performance.

The true density refers to the actual mass of solid matter per unit volume of the material in an absolutely compact state, that is, the density after removing the internal pores or the voids between particles. The determination method refers to GB/T 24586-2009.

When the layered transition metal oxide is selected from a plurality of oxides, ρ₁ indicates the average value of true densities of a plurality of the layered transition metal oxides. The polyanionic compound is selected from a plurality of oxides, ρ₂ indicates the average value of true densities of a plurality of the polyanionic compounds.

The mechanism of the present disclosure includes: it is assumed that all particles are spherical particles, and the spherical particles are arranged in a way of sphere stacking, where second-level particles are filled between first-level particles, third-level particles are filled between the first-level particles and the second-level particles, and so forth, the porosity of the first-level particles is ˜38%, the porosity of the second-level particles is ˜15%, the porosity of the third-level particles is ˜5%, and the porosity of fourth-level particles is ˜2%, and when the distribution of particles of different sizes reaches the third level, filling with smaller particles may not greatly reduce the porosity and increase the volume density of the particles. Therefore, the present disclosure is based on the accumulation of three-level particles, wherein the filling and accumulation are performed with D₅₀ of the transition metal oxide as the first-level particles and D₁₀ thereof as the second-level particles, and D₅₀ of the polyanionic compound as the third-level particles, and the sizes of the second-level particles and the third-level particles are calculated according to the size of the first-level particles, respectively. Through the coordination of the first three levels of particles (D₅₀ of the transition metal oxide, D₁₀ of the transition metal oxide, and D₅₀ of the polyanionic compound), the density of accumulation (corresponding to the compaction density/volume density of the electrode plate) may be effectively increased.

When the sizes of the particles of individual level are obtained, in order to improve the air sensitivity of the layered transition metal oxide, it at least needs to make the polyanionic compound in the electrode plate evenly distributed on the outer layer of the layered oxide, to block the contact between the layered transition metal oxide and air. Assuming that all particles are spheres, D₅₀ of the transition metal oxide and D₅₀ of the polyanionic compound are regarded as the average particle sizes, the surface area of the spherical particles of the corresponding metal oxide may be obtained by calculation. In order to ensure the desired effect (the polyanionic compound coats the transition metal oxide in the middle), the polyanionic compound is further assumed to be circular, and the sum of all circular areas is not less than the surface area of the layered oxide, therefore, according to the areas of the transition metal oxide and the polyanionic compound, the relationship between the number of particles of the transition metal oxide and the number of particles of the polyanionic compound may be further obtained, and by combining the particle sizes, the numbers of particles, and the true densities of the transition metal oxide and the polyanionic compound, the final mass relationship between the two materials may be obtained.

Therefore, through the control of parameters such as particle distribution and mass ratio, it may not only increase the compaction density, but also reduce the air sensitivity of the material. While the compaction density is increased, the pores are reduced to a certain extent, and contact between the metal oxide and air is reduced. The metal oxide has high capacity and poor circulation, while the polyanionic compound has low capacity and good circulation, the metal oxide, as the main body, is compounded with a part of the polyanionic compound, to improve cycle performance while ensuring high capacity.

In an embodiment, the particle size of the polyanionic compound satisfies:

$${D ’}_{50} \leq \frac{( \sqrt{2} - 1 )}{4} {D}_{50} .$$

In an embodiment, x includes but is not limited to 0.6, 0.7, 0.8, 0.9 or 1.0. The chemical formula of the layered transition metal oxide includes NaNi_{1/3}Fe_{1/3}Mn_{1/3}O₂, NaNi_{1/3}Fe_{1/3}Mg_{1/3}O₂, NaNi_{1/5}Fe_{2/5}Mn_{2/5}O₂, NaNi_{1/3}Fe_{1/3}Ti_{1/3}O₂, NaNi_{3/9}Fe_{3/9}Mn_{2/9}Zr_{1/9}O₂, Na_{0.9}Cu_{0.25}Fe_{0.3}Mn_{0.45}O₂, Na_{2/3}Ni_{1/3}Mn_{5/6}Ti_{1/6}O₂, Na_{0.75}MnO₂, Na_{2/3}Mn_{2/3}Ni_{1/3}O₂, Na_{2/3}Mn_{5/9}Ni_{3/9}Cr_{1/9}O₂, or NaNi_{1/5}Fe_{1/5}Cu_{1/5}Mn_{2/5}O₂, and so forth.

In an embodiment, the polyanionic compound NaAPO₄ is NaFePO₄, or NaMnPO₄. In an embodiment, in Na_{y}E₂(XO₄)₃. y includes but is not limited to 1, 2, 3, and 4, and Na_{y}E₂(XO₄)₃ may be NaV₂(PO₄)₃, NaFe₂(PO₄)₃, NaNi₂(PO₄)₃, NaTi₂(PO₄)₃, NaV₂(SO₄)₃, or NaV₂(SiO₄)₃, and so forth. In an embodiment, Na₂QP₂O₇ is Na₂FeP₂O₇, Na₂MnP₂O₇, or Na₂CoP₂O₇.

In an embodiment, the range of ρ₁ is 4.4˜4.65 g/cm³, such as 4.5 g/cm³, 4.52 g/cm³, or 4.6 g/cm³, and so forth. The range of ρ₂ is 2.5˜3.5 g/cm³, such as 2.64 g/cm³, 2.72 g/cm³, 2.8 g/cm³, 3 g/cm³ or 3.2 g/cm³, and so forth.

In an embodiment, the value of ρ₁/ρ₂ includes but is not limited to 1.3, 1.4, 1.46, 1.5, 1.52, 1.6, or 1.8, and so forth.

In an embodiment, the particle size D₅₀ of the layered transition metal oxide is 4˜12 μm, such as 5.03 μm, 6.87 μm, 7.4 μm, 8 μm, 9 μm, or 10 μm, and so forth.

In an embodiment, the particle size D₁₀ of the layered transition metal oxide is 1.27˜3.82 μm, such as 1.3 μm, 1.52 μm, 1.83 μm, 2.44 μm, 2.5 μm, 2.8 μm, 3 μm, 3.15 μm, 3.5 μm, 3.76 μm, and so forth.

In an embodiment, the particle size D′50 of the polyanionic compound is 0.41˜1.24 μm, such as 0.44 μm, 0.51 μm, 0.62 μm, 0.7 μm, 0.9 μm, 1 μm, or 1.2 μm, and so forth.

In an embodiment, the cathode material layer further includes a conductive agent and a bonding agent.

In an embodiment, the conductive agent includes at least one of carbon nanotube (CNT), conductive carbon black (SP), conductive graphite, graphene, and carbon fiber. In an embodiment, the conductive agent includes conductive carbon black and carbon nanotube, and the mass ratio of conductive carbon black to carbon nanotube is (1˜3): 0.5, such as 1:0.5, 1.5:0.5, 2:0.5, 2.5:0.5, and 2.8:0.5, and so forth.

In an embodiment, the bonding agent includes at least one of polyvinylidene fluoride (PVDF), polytetrafluoroethylene, polyacrylic acid, polyacrylonitrile, styrene-butadiene rubber, and polyimide.

In an embodiment, the total mass of the conductive agent and the bonding agent accounts for no more than 5% of the mass of the at least one cathode material layer, such as 0.5%, 0.8%, 1%, 1.5%, 2%, 3%, 4%, 4.8%, and so forth. In an embodiment, the ratio of the total mass of the conductive agent and the bonding agent to the mass of the cathode material layer is 1%˜4.8%.

In an embodiment, in the cathode material layer, the mass ratio of the conductive agent to the bonding agent is (1.5-3.5):(1.5-3.5), such as 1.5:3.5, 2:3, 3.5:1.5, and so forth.

In an embodiment, the compaction density of the positive plate is 3.0˜3.6 g/cm³, such as 3.1 g/cm³, 3.2 g/cm³, 3.3 g/cm³, 3.4 g/cm³, 3.5 g/cm³, and so forth.

According to another aspect of the present disclosure, the present disclosure further relates to a preparation method of the positive plate, including the following steps:
preparing a cathode slurry, wherein the cathode slurry contains the layered transition metal oxide and the polyanionic compound; and coating the cathode slurry on the at least one side surface of the current collector, and then performing drying and compacting.

The preparation method of the positive plate of the present disclosure is simple and easy to be operated, i.e., coating the cathode slurry containing the layered transition metal oxide and the polyanionic compound on the at least one side surface of the current collector, and then performing drying and compacting.

In an embodiment, the current collector in the present disclosure includes aluminum foil or composite aluminum foil.

In an embodiment, the cathode slurry further includes the conductive agent, the bonding agent, and solvent. In an embodiment, the solvent includes N-methyl pyrrolidone (NMP).

The preparation method of the cathode slurry specifically includes: dissolving the bonding agent into the solvent, adding the conductive agent and dispersing them evenly to obtain a uniform conductive slurry; and then adding the layered transition metal oxide and the polyanionic compound into the conductive slurry, and dispersing them evenly to obtain the cathode slurry.

In an embodiment, a temperature of the drying is 75˜120° C. In an embodiment, a temperature of the drying is 80° C., 90° C., 95° C., 100° C., 110° C. or 115° C., and so forth.

In an embodiment, a pressure adopted by the compacting is 20˜100 MPa. In an embodiment, a pressure adopted by the compacting is 30 MPa, 40 MPa, 50 MPa, 60 MPa, 70 MPa, 80 MPa, 90 MPa, 95 MPa, and so forth.

According to another aspect of the present disclosure, the present disclosure also relates to a sodium-ion battery, including the positive plate. The sodium-ion battery of the present disclosure has excellent electrochemical performance.

Further explanations and illustrations are given blow in conjunction with specific embodiments, and comparative examples.

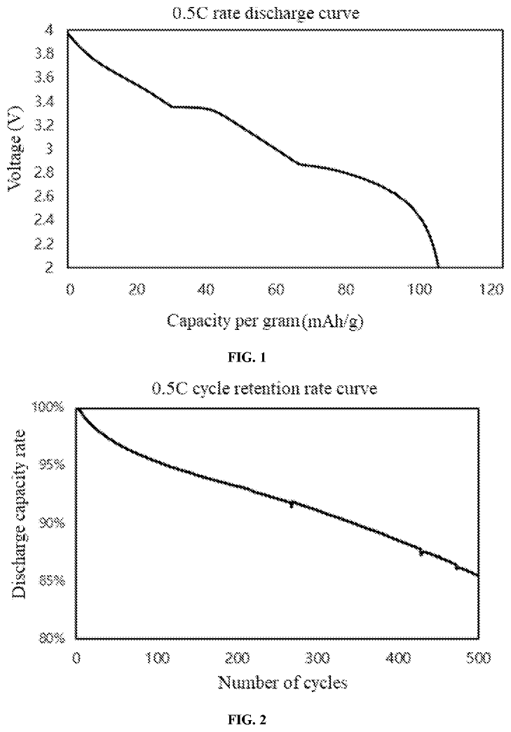

A discharge curve diagram of a cell in Example 1 of the present disclosure is shown in FIG. 1.

A curve diagram of a cycle retention rate of a cell in Example 3 of the present disclosure is shown in FIG. 2.

### Example 1

A preparation method of a positive plate included the following steps:
(a) dissolving 2.0 parts by mass of PVDF in NMP solvent, then adding 2.0 parts by mass of SP and 0.5 parts by mass of CNT as conductive agents, and dispersing them evenly to obtain a conductive slurry S1;
(b) adding cathode materials, 75.5 parts by mass of layered transition metal oxide NaNi_{1/3}Fe_{1/3}Mn_{1/3}O₂ and 20.0 parts by mass of polyanionic compound Na₃V₂(PO₄)₃, to the first conductive slurry of step (a), wherein in the cathode material NaNi_{1/3}Fe_{1/3}Mn_{1/3}O₂, D₁₀=2.44 μm, D₅₀=6.87 μm, and the true density was 4.50 g/cm³, and in the cathode material Na₃V₂(PO₄)₃. D₅₀=0.51 μm, and the true density was 3.24 g/cm³, and dispersing them evenly to obtain a slurry S2; and
(c) coating the above-mentioned slurry S2 on the aluminum foil evenly, and bake-drying and rolling the same to obtain the positive plate.

The positive plate of the present example, negative plate, separator, electrolyte, and so forth were assembled to form a battery, which was subjected to processes such as maturing, formation, and aging to obtain a cell to be tested.

### Example 2

The preparation method of the positive plate was the same as in Example 1, except that the layered transition metal oxide was 88 parts by mass and the polyanionic compound was 7.5 parts by mass.

### Example 3

The preparation method of the positive plate was the same as in Example 1, except that the layered transition metal oxide was Na_{0.9}Cu_{0.25}Fe_{0.3}Mn_{0.45}O₂, with particle size D₁₀=1.83 μm, particle size D₅₀=5.03 μm, and the true density of 4.55 g/cm³.

### Example 4

The preparation method of the positive plate was the same as in Example 1, except that the polyanionic compound was NaFePO₄, with particle size D₅₀=0.44 μm, and the true density of 3.14 g/cm³.

### Example 5

The preparation method of the positive plate was the same as in Example 1, except that the layered transition metal oxide contained NaNi_{1/3}Fe_{1/3}Mn_{1/3}O₂ and Na_{0.9}Cu_{0.25}Fe_{0.3}Mn_{0.45}O₂ with a mass ratio of 1:1, the polyanionic compound contained NaFePO₄, Na₃V₂(PO₄)₃, and Na₂MnP₂O₇ with a mass ratio of 1:1:1, and the true density of Na₂MnP₂O₇ was 3.26 g/cm³.

### Comparative Example 1

A preparation method of a positive plate included the following steps:
(a) dissolving 2.0 parts of PVDF in NMP solvent, then adding 2.0 parts of SP and 0.5 parts of CNT as the conductive agent, and dispersing them evenly to obtain a conductive slurry S1;
(b) adding the cathode material 95.5 parts of layered transition metal oxide NaNi_{1/3}Fe_{1/3}Mn_{1/3}O₂ into the S1, wherein in the cathode material of NaNi_{1/3}Fe_{1/3}Mn_{1/3}O₂, D₁₀=2.44 μm, D₅₀=6.87 μm, and dispersing them evenly to obtain a slurry S2; and
(c) coating the above-mentioned slurry S2 on the aluminum foil evenly, and bake-drying and rolling the same to obtain the positive plate.

The positive plate of the present comparative example, negative plate, separator, electrolyte, and so forth were assembled to obtain a battery, which was subjected to processes such as maturing, formation, and aging, to obtain a cell to be tested.

### Comparative Example 2

A preparation method of a positive plate included the following steps:
(a) dissolving 2.0 parts of PVDF in NMP solvent, then adding 2.0 parts of SP and 0.5 parts of CNT as the conductive agent, and dispersing them evenly to obtain a conductive slurry S1;
(b) adding the cathode material 95.5 parts of polyanionic compound Na₃V₂(PO₄)₃ into the S1, wherein in the cathode material of Na₃V₂(PO₄)₃, D₅₀=0.51 μm, and dispersing them evenly to obtain a slurry S2; and
(c) coating the above-mentioned slurry S2 on the aluminum foil evenly, and bake-drying and rolling the same to obtain the positive plate.

The positive plate of the present comparative example, negative plate, separator, electrolyte, and so forth were assembled to obtain a battery, which was subjected to processes such as maturing, formation, and aging, to obtain a cell to be tested.

### Comparative Example 3

The preparation method of the positive plate was the same as in Example 1, except that in the layered transition metal oxide, the particle size D₁₀=2.8 μm, the particle size D₅₀=15 μm, and the true density was 4.49 g/cm³, and in the polyanionic compound, the particle size D₅₀=1.65 μm, and the true density was 3.25 g/cm³.

### Experimental Example

Electrochemical performance test was performed on the positive plates and the sodium-ion batteries in the examples and the comparative examples by the following method.

### I. Residual Alkali Test

The positive plate was placed in an environment with a humidity of 26±3% for 12 hours, and then the powder on the electrode plate was separated from the aluminum foil, and transferred to a beaker, followed with adding deionized water, stirring for 60 seconds, filtering, transferring the filtrate to a sample table of the potentiometric titrator, and performing potentiometric titration with hydrochloric acid. The carbonate and bicarbonate obtained in the test were converted into sodium-ion content, wherein the content calculation basis was the mass of the layered transition metal oxide in the cathode powder after separated from the aluminum foil.

### II. Capacity Test

It was charged to 4.0V and a cut-off current 0.05 C, with a constant current and constant voltage at a rate of 0.5 C, followed by standing for 30 minutes, then being discharged to 2.0V with a constant current at a rate of 0.5 C. The battery capacity was recorded and converted into a gram capacity according to the mass of the active material in the positive plate, with the gram capacity recorded as a reversible capacity.

### III. Cycle Performance Test

At 45±2° C., it was charged to 4.0V and a cut-off current 0.05 C, with a constant current and constant voltage at a rate of 0.5 C, followed by standing for 30 minutes, then being discharged to 2.0V with a constant current at a rate of 0.5 C, standing for 30 minutes, and cycling/repeating the process for 500 times. The ratio of the 500th capacity to the initial capacity was recorded as the capacity retention rate.

The test results are shown in Table 1.

TABLE 1
Performance test results

| | | Electrode | | |
|---|---|---|---|---|
| | Residual alkali | plate | | Retention rate |
| | test after | compaction | Reversible | after cycling |
| | buffering | density | capacity | for 500 times |
| Group | (ppm) | (g/cm³) | (mAh/g) | (%) |
| Example 1 | 587 | 3.60 | 103.1 | 84.6 |
| Example 2 | 498 | 3.55 | 104.4 | 83.2 |
| Example 3 | 451 | 3.42 | 103.4 | 85.4 |
| Example 4 | 504 | 3.35 | 101.0 | 83.4 |
| Example 5 | 599 | 3.47 | 102.8 | 82.9 |
| Comparative | 6540 | 2.82 | 106.6 | 62.4 |
| Example 1 | | | | |
| Comparative | 259 | 2.16 | 92.4 | 86.1 |
| Example 2 | | | | |
| Comparative | 3518 | 2.95 | 101.5 | 69.4 |
| Example 3 | | | | |

It may be seen from Table 1 that in each example of the present disclosure, the layered transition metal oxide with large particle size and the polyanionic compound with small particle size are filled with each other, wherein the polyanionic compound, regarded as the main part, and the conductive agent and the bonding agent, regarded as the auxiliary part, are evenly dispersed on the surface of the layered transition metal oxide, which on the one hand enables the positive plate to have a higher compaction density, to effectively increase the energy density of the battery, and on the other hand, enables the combined positive plate has both better air stability and cycle performance.

Compared with Embodiment 1, the active material of Comparative Example 1 only adopts the layered transition metal oxide, and the obtained positive plate has low compaction density and poor retention rate after cycling for 500 times.

Compared with Embodiment 1, the active material of Comparative Example 2 only adopts the polyanionic compound, and the obtained positive plate has low compaction density and low reversible capacity.

Compared with Embodiment 1, the particle size distribution of the active material in Comparative Example 3 is not within the protection scope of the present disclosure, and the obtained positive plate has low compaction density and poor cycle retention rate.

Finally, it should be noted that the above embodiments are merely used for illustrating the technical solutions of the present disclosure, rather than limiting the present disclosure. Although the detailed description is made to the present disclosure with reference to the preceding embodiments, those ordinarily skilled in the art should understand that they still may make modifications for the technical solutions recited in the preceding embodiments, or make equivalent substitutions to some or all of the technical features therein, and these modifications or substitutions do not make the essence of the corresponding technical solutions depart from the scope of the technical solutions of embodiments of the present disclosure.

Those skilled in the art will readily observe that numerous modifications and alterations of the device and method may be made while retaining the teachings of the invention. Accordingly, the above disclosure should be construed as limited only by the metes and bounds of the appended claims.

1. A positive plate, comprising a current collector and at least one cathode material layer provided on at least one side surface of the current collector, wherein the at least one cathode material layer comprises a layered transition metal oxide and a polyanionic compound;
a chemical formula of the layered transition metal oxide comprises NaₓMO₂, wherein 0.6≤x≤1.0, and M comprises at least one selected from the group consisting of Fe, Mn, Cr, Ni, Co, Cu, Mg, Zr, and Ti;
a chemical formula of the polyanionic compound comprises at least one selected from the group consisting of NaAPO₄, Na_{y}E₂(XO₄)₃, and Na₂QP₂O₇, wherein A comprises Fe and/or Mn, 1≤y≤4, E comprises at least one selected from the group consisting of V, Fe, Ni, Mn, and Ti, X comprises at least one selected from the group consisting of P, S, and Si, and Q comprises at least one selected from the group consisting of Fe, Mn, and Co;
a mass ratio of the layered transition metal oxide to the polyanionic compound is (\textcircled{2}+1)ρ₁/ρ₂˜4(\sqrt{2}+1)ρ₁/ρ₂, wherein ρ₁ indicates a true density of the layered transition metal oxide, ρ₂ indicates a true density of the polyanionic compound, and 1.25≤ρ₁/ρ₂≤1.86;
a particle size distribution of the layered transition metal oxide satisfies: (\sqrt{3}−\sqrt{2})D₅₀≤D₁₀≤(\sqrt{2}−1)D₅₀; and
a particle size of the polyanionic compound satisfies:
$${{D}^{′}}_{50} \leq \frac{( \sqrt{2} - 1 )}{4} {D}_{50} .$$

2. The positive plate according to claim 1, wherein a range of ρ₁ is 4.4˜4.65 g/cm³; and a range of ρ₂ is 2.5˜3.5 g/cm³.

3. The positive plate according to claim 1, wherein at least one of (1) to (3) are comprised:
(1) a particle size D₅₀ of the layered transition metal oxide is 4˜12 μm;
(2) a particle size D₁₀ of the layered transition metal oxide is 1.27˜3.82 μm; and
(3) a particle size D′₅₀ of the polyanionic compound is 0.41˜1.24 μm.

4. The positive plate according to claim 1, wherein at least one of (1) to (5) are comprised:
(1) the at least one cathode material layer further comprises a conductive agent and a bonding agent;
(2) the conductive agent comprises at least one selected from the group consisting of carbon nanotube, conductive carbon black, conductive graphite, graphene, and carbon fiber;
(3) the bonding agent comprises at least one selected from the group consisting of polyvinylidene fluoride, polytetrafluoroethylene, polyacrylic acid, polyacrylonitrile, styrene-butadiene rubber, and polyimide;
(4) a total mass of the conductive agent and the bonding agent accounts for no more than 5% of a mass of the at least one cathode material layer; and
(5) in the at least one cathode material layer, a mass ratio of the conductive agent to the bonding agent is (1.5-3.5):(1.5-3.5).

5. The positive plate according to claim 1, wherein a compaction density of the positive plate is 3.0˜3.6 g/cm³.

6. A preparation method of the positive plate according to claim 1, comprising:
preparing a cathode slurry, wherein the cathode slurry contains the layered transition metal oxide and the polyanionic compound; and
coating the cathode slurry on the at least one side surface of the current collector, and then performing drying and compacting.

7. The preparation method of the positive plate according to claim 6, wherein the cathode slurry further contains a conductive agent, a bonding agent, and a solvent.

8. The preparation method of the positive plate according to claim 7, wherein a preparation method of the cathode slurry comprises:
dissolving the bonding agent into the solvent, adding the conductive agent and mixing them evenly to obtain a conductive slurry; and
mixing the conductive slurry, the layered transition metal oxide, and the polyanionic compound evenly, to obtain the cathode slurry.

9. The preparation method of the positive plate according to claim 6, wherein at least one of (1) to (2) are comprised:
(1) a temperature of the drying is 75˜120° C.; and
(2) a pressure adopted by the compacting is 20˜100 MPa.

10. A sodium-ion battery, comprising the positive plate according to claim 1.

11. The preparation method of the positive plate according to claim 6, wherein a range of ρ₁ is 4.4˜4.65 g/cm³; and a range of ρ₂ is 2.5˜3.5 g/cm³.

12. The preparation method of the positive plate according to claim 6, wherein at least one of (1) to (3) are comprised:
(1) a particle size D₅₀ of the layered transition metal oxide is 4˜12 μm;
(2) a particle size D₁₀ of the layered transition metal oxide is 1.27˜3.82 μm; and
(3) a particle size D′₅₀ of the polyanionic compound is 0.41˜1.24 μm.

13. The preparation method of the positive plate according to claim 6, wherein at least one of (1) to (5) are comprised:
(1) the at least one cathode material layer further comprises a conductive agent and a bonding agent;
(2) the conductive agent comprises at least one selected from the group consisting of carbon nanotube, conductive carbon black, conductive graphite, graphene, and carbon fiber;
(3) the bonding agent comprises at least one selected from the group consisting of polyvinylidene fluoride, polytetrafluoroethylene, polyacrylic acid, polyacrylonitrile, styrene-butadiene rubber, and polyimide;
(4) a total mass of the conductive agent and the bonding agent accounts for no more than 5% of a mass of the at least one cathode material layer; and
(5) in the at least one cathode material layer, a mass ratio of the conductive agent to the bonding agent is (1.5-3.5):(1.5-3.5).

14. The preparation method of the positive plate according to claim 6, wherein a compaction density of the positive plate is 3.0˜3.6 g/cm³.

15. The sodium-ion battery according to claim 10, wherein a range of ρ₁ is 4.4˜4.65 g/cm³; and a range of ρ₂ is 2.5˜3.5 g/cm³.

16. The sodium-ion battery according to claim 10, wherein at least one of (1) to (3) are comprised:
(1) a particle size D₅₀ of the layered transition metal oxide is 4˜12 μm;
(2) a particle size D₁₀ of the layered transition metal oxide is 1.27˜3.82 μm; and
(3) a particle size D′₅₀ of the polyanionic compound is 0.41˜1.24 μm.

17. The sodium-ion battery according to claim 10, wherein at least one of (1) to (5) are comprised:
(1) the at least one cathode material layer further comprises a conductive agent and a bonding agent;
(2) the conductive agent comprises at least one selected from the group consisting of carbon nanotube, conductive carbon black, conductive graphite, graphene, and carbon fiber;
(3) the bonding agent comprises at least one selected from the group consisting of polyvinylidene fluoride, polytetrafluoroethylene, polyacrylic acid, polyacrylonitrile, styrene-butadiene rubber, and polyimide;
(4) a total mass of the conductive agent and the bonding agent accounts for no more than 5% of a mass of the at least one cathode material layer; and
(5) in the at least one cathode material layer, a mass ratio of the conductive agent to the bonding agent is (1.5-3.5):(1.5-3.5).

18. The sodium-ion battery according to claim 10, wherein a compaction density of the positive plate is 3.0˜3.6 g/cm³.
